(19) United States
(12) Patent Application Publication
(10) Pub. No.: US 2005/0102147 A1
(43) Pub. Date: May 12, 2005

(54) Method of speech-based navigation in a communications network and of implementing a speech input possibility in private information units

(76) Inventors: Meinhard Ullrich, Aachen (DE); Eric Thelen, Aachen (DE); Stefan Besling, Aachen (DE)

Correspondence Address: BROMBERG & SUNSTEIN LLP, 125 SUMMER STREET, BOSTON, MA, 02110-1618, US

(21) Appl. No.: 10/960,775

(22) Filed: Oct. 7, 2004

Related U.S. Application Data
(63) Continuation of application No. 09/387,627, filed on Aug. 31, 1999, now abandoned.

(30) Foreign Application Priority Data
Jun. 9, 1999 (DE) DE 19926213.6
Jul. 2, 1999 (DE) DE 19930407.6

(51) Int. Cl. G10L 11/00

(52) U.S. Cl. 704/270.1

(57) ABSTRACT

The method enables a user of a client (2) to invoke predefined information units in a communications network per speech input. For this purpose, a client (2) downloads a private information unit (27) that enables a speech input from a server (6), a speech recognizer (8) produces a recognition result from an uttered speech input and with the recognition result a link (44-46, 48) to an information unit is determined in a data file (5) to which information unit a word (41-43, 47) is assigned that correlates with the recognition result. Furthermore, with a method of implementing a speech input possibility in private information units (27) for the speech-based navigation in a communications network (4), a registration information unit (19) is downloaded from a server (6) by means of a client (1), by means of which registration information unit (19) user-specific links (46) are assigned to predefined words (41-43) and the assignment (25, 26) with a user identifier (IDn) is transmitted to a data file (5) and the user identifier (IDn) and an address of a speech recognizer (8), which can each be combined with a private information unit (27), are transmitted to the client (1).

This application is a continuation of U.S. patent application Ser. No. 09/387,627, filed Aug. 31, 1999, which in turn claimed foreign priority under 35 U.S.C. §119 from German Patent Application 19926213.6, filed Jun. 9, 1999, and from German Patent Application 19930407.6, filed Jul. 2, 1999.

### FIELD OF THE INVENTION

The invention relates to a method of speech-based navigation and to a method of implementing a speech input possibility in private information units for speech-based navigation in a communications network.

### BACKGROUND ART

The distribution of information via networks becomes ever more complex. As a result, the Internet obtains growing importance as a communications network. To access information from the Internet it is important to utilize respective aiding means which simplify the finding of information.

Man's most common means of communication is speech. Utilizing speech as an input medium for communication with a computer does have some difficulties, however. A program executing speech recognition, in the following to be denoted a speech recognizer, is to be adapted, on the one hand, to the vocabulary which it is to understand and, on the other hand, to the speaker's pronunciation. For achieving satisfactory recognition results, a costly training is necessary. A basis for the speech recognition is further a powerful computer. This prerequisite is not satisfied in most computers by which users invoke information units. Local speech recognition systems are mostly arranged for only one user who must carry out a costly training of the vocabulary used by him, as described earlier.

DE 44 40 598 C I describes a hypertext navigation system controlled by spoken words. With a local speech recognizer, to which are assigned lexicons and probability models for supporting an acoustic speech recognition of hyperlinks of the hypertext documents, is enabled to control a browser or viewer. The system permits a pronunciation of links during which the speech recognition is adapted to the links to be recognized, without these links having to be known beforehand. For this purpose, the hypertext documents contain additional data which are necessary for adapting the speech recognizer. These additional data are generated either in the calling user system, or assigned to the hypertext documents by the provider and co-transmitted when retrieved by the user system.

DE 197 07 973 A1 discloses a method of executing actions by means of speech input on a computer in a network system, more particularly, the Internet. For this purpose, the user's computer includes a local speech recognizer whose parameters are defined by the respective service provider for executing the speech recognition process and are transmitted from the service provider to the user when the user so requests.

Such local speech recognition systems require a powerful computer and their flexibility with respect to the vocabulary is limited. An increase of the flexibility increases the number of data to be transmitted, because the parameters necessary for tuning the local speech recognizer to the local computer are to be transmitted. The transmission of a large number of data while having a limited transmission capacity, however, costs much more time.

### SUMMARY OF THE INVENTION

Therefore, it is an object of the invention to enable a speech-based navigation for information units to predefined web sites. According to the invention this object is achieved in that a client downloads from a server a private information unit that enables a speech input, and a speech recognizer generates a recognition result from an uttered speech input, and with the recognition result a link in a data file is determined, which link is assigned to a word that correlates with the recognition result.

A user program which is mostly denoted a browser or viewer is executed on a client to indicate and display the information units. The calling client is connected via a respective connection in a communications network to a server of a service provider, which server enables accessing, for example, the Internet. An information unit is invoked by keying in an IP address or a URL (Universal Resource Locator). A further possibility of invoking information is provided by links or hyperlinks. These links will have a different color or will be underlined in the rest of the text. By clicking this link with the mouse, the information unit is invoked that goes with the link. Indicating information units and invoking further information units based on the information unit then indicated is called navigating. The information in the form of information units is offered by service providers and firms on the Internet and made accessible. Also private information units which are specifically called home pages are ever more offered on the Internet. The respective owner or maker of the home page then puts interesting information on this home page. Mostly such home pages contain details about the person, contributions to hobbies with, for example, photos. Furthermore, the owners of the home pages often indicate important links which a visitor to the home page should also have a look at. Also firms can create home pages and make them accessible on the Internet and mostly the first web page of a web site is called home page from which a user can navigate to other company-specific web pages.

A client downloads a private information unit from a server which is connected to the client through the communications network. This information unit is indicated to a user by means of a browser. The user is requested, for example, by information shown, to give a speech input. This speech input is transferred to a speech recognition server and fed there to a speech recognizer which carries out a speech recognition process. The recognition result produced by the speech recognizer is sent back to the client. The client transmits the recognition result to a data file. This data file is situated on a data file server on which a link correlating with the speech utterance is determined. The speech utterance then corresponds to a word to which a link is assigned.

In a further embodiment of the invention there is provided that the private information unit contains a user identifier. A recognition result produced by the speech recognizer from a speech input uttered by a user is transmitted with the user identifier to the data file. In the data file a link is determined with the aid of the recognition result and the user identifier. The data file contains assignments of links to words or user identifiers. In the case where there is correlation between a word from the assignment to the respective user identifier and the recognition result, the assigned link is returned to the client.

The determined link can be directly returned to the client, so that the user is to invoke the respective link himself. It proves to be highly advantageous, however, for the data file server to activate the determined link and for the connected information unit to be delivered and indicated to the client.

In a further embodiment of the invention it proves to be advantageous to give the private information unit an address of a speech recognition server on the Internet. This address is transmitted to the client when the private information unit is invoked. Speech inputs uttered by the user are then transmitted through the communications network to a speech recognizer on the speech recognition server, which speech recognizer then carries out the speech recognition. The recognition result produced by the speech recognizer is transmitted to the client. The higher calculation power of such a speech recognizer is advantageous when the recognition result is produced on a speech recognition server. These speech recognizers are specialized and have a specially tailored vocabulary, so that a speaker-independent speech recognition is possible. This achieves that there is a higher recognition rate and that the recognition result is available more rapidly.

In a further embodiment there is provided to locally carry out the speech recognition on the computer. For simple applications with a limited vocabulary and a sufficiently powerful computer, the speech recognition is executed locally on the client. As a result, there is no need to transmit to a remote speech recognizer, so that transmission errors are reduced. Furthermore, it is an object of the invention to implement a speech input possibility for home pages without the use of a local speech recognizer.

The object of implementing a possibility of speech input in home pages without the use of a local speech recognizer is achieved in that a registration information unit is downloaded from a server by means of a client, by means of which registration information unit user-specific links are assigned to predefined words, and the assignment with a user identifier is transmitted to a data file and in which the user identifier and an address of a speech recognizer, which can each be combined with a private information unit, are transmitted to the client.

A user who would like to implement a speech input possibility in his private information unit downloads a registration information unit from a server. On this registration information unit respective links are assigned to words predefined by the user. The assignment takes place by means of the keyboard and/or the mouse. When doing so the user assigns these links, which are connected to respective information units on the Internet, according to his own ideas. This user-specific assignment of words to personal links is transmitted to a data file. The data file stores this assignment linked with a user identifier. The user identifier and an address of a speech recognition server on which the speech recognizer is provided, are then transmitted to the client. This user identifier and the address of the speech recognizer are combined with this private information unit by the user of the client who is also denoted the owner/maker of the private information unit. By storing the assignment on the data file server with the individual user identifier and combining the user identifier with the private information unit, a speech input possibility in private information units is implemented. The maker of the home page enables the visitors to his home page to speak the respective predefined words and thus arrive by speech input at the information unit assigned by him per link, without the visitors executing a local speech recognition program on the invoking client.

In a further embodiment of the invention there is provided that the speech recognizer recognizes not only the predefined words. The speech recognizer also recognizes user-independent words. A service provider assigns a respective user-independent link to these user-independent words. Always when the speech recognizer produces a recognition result from a speech utterance, which result correlates with a user-independent word, a user-independent link is returned to the client to which the service provider assigned the respective user-independent word. It is also possible not to return the user-independent link to the client, but to send to the client directly the information unit connected with the user-independent link.

In a preferred embodiment of the invention there is provided to check, on the one hand, when the registration information unit is invoked and, on the other hand, when the private information unit in the speech input possibility is invoked, whether a software module is executed on the respectively invoking client. This software module executes a feature extraction. The speech input data which are led to this software module by means of an input medium, for example, a microphone and are available as an electric signal, are quantized by this software module and subjected to respective analyses which produce components which are assigned to feature vectors. These feature vectors are thereafter transmitted to the coupled speech recognizers. The software module furthermore takes over the handling of the transmission of the feature vectors and the reception of the recognition result and the transmission of the user identifier and recognition result to the data file server and the reception of the link. When the software module is not available, it is also downloaded from the server on which the information units to be invoked are stored.

For users of a client who do not have their own home page and, in consequence, cannot combine the user identifier and the address of a speech recognizer with this home page, there is provided to transmit to these users an information unit containing both the individual user identifier and an address of a speech recognizer. This information unit is indicated by the browser executed on the client and enables the user to invoke the information units per speech input via the links to which he has assigned respective predefined words and which were assigned to user-independent words by the service provider.

It proves to be advantageous when the data file, in which the assignment is stored with the user identifiers, and the speech recognizer are located on one server. This is advantageous in that the recognition result need not first be transmitted to the client again and from there to the data file server, but the recognition result is directly transmitted to the common server of the data file. The respective user identifier is then transmitted to the common server together with the feature vectors. This saves on delay and at the same time minimizes the error probability as a result of transmission errors that occur.

Furthermore, the object of the invention is achieved by means of a software module which assigns the speech input data to feature vectors. This software module transmits the feature vectors to the speech recognizers laid down in the address. The recognition result produced by the speech recognizer is received from this software module and transmitted to a data file together with the user identifier. A determined link is received from the software module and invoked, so that the information unit connected with the link is offered to the user of the invoking client.

In a preferred embodiment of the invention the software module is activated by means of an operating element. Activating this operating element represented, for example, as a button will start the recording of speech input data.

The object of the invention is also achieved by a computer on which a software module described above is executed.

These and other aspects of the invention are apparent from and will be elucidated with reference to the embodiments described hereinafter.

### BRIEF DESCRIPTION OF THE DRAWING

FIG. 1 shows a structure for executing the method according to the invention.

FIG. 2 shows a block diagram for the speech-based navigation of a home page.

FIG. 3 shows the routine of a speech-based navigation.

FIG. 4 shows a block diagram for the implementation of a speech input possibility in home pages.

FIG. 5 shows the routine of the implementation of a speech input possibility.

### DETAILED DESCRIPTION OF SPECIFIC EMBODIMENTS

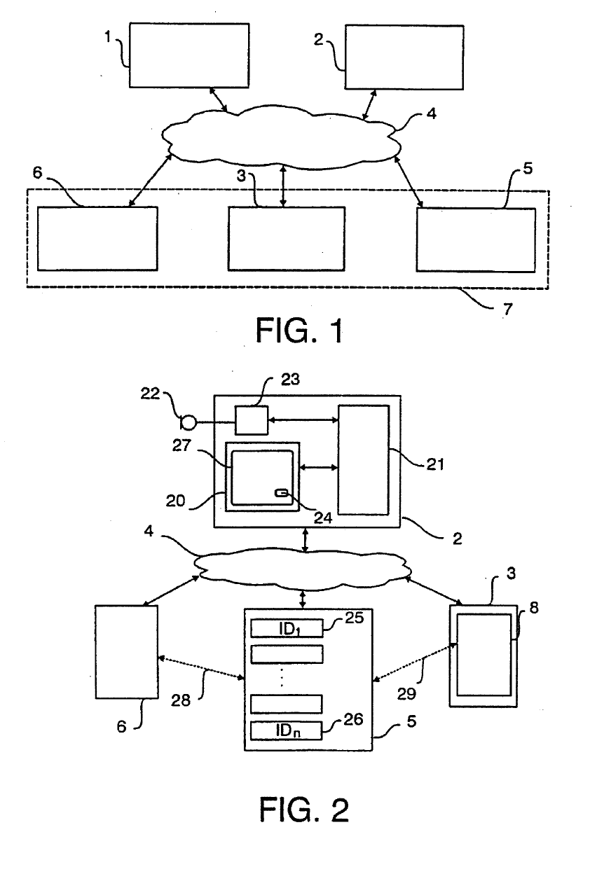

FIG. 1 shows a structure in which elements that are necessary for implementing the method according to the invention are represented. For implementing the method according to the invention, several clients 1 and 2, one speech recognition server 3, one server 6 and one data file server 5 are arranged. These computers are interconnected via a data network 4. The communications network 4 may then be realized both by the Internet and by an intranet and/or extranet. The individual communications networks 4 in principle are only different in that they have limited user groups which have access to these communications networks.

The clients 1 and 2 are computers from where users invoke information units in the following to be referenced as home pages and/or web pages by means of a browser executed there. The information units which are put on the Internet by companies are denoted web sites. The input information unit of such a web site and information units of private persons are denoted home pages. A web site is understood to mean a collection of web pages which belong together. These home pages and web sites are stored, for example, on a server 6.

The speech recognition server 3 is a powerful computer on which a speech recognition program is executed. This speech recognition server 3 has an application-specific vocabulary that its architecture is optimized for the speech recognition. The data file server 5 is also a computer which is connected to the Internet 4. Assignments are stored on this data file server 5 connected to the Internet 4.

FIG. 2 shows an arrangement as is necessary for executing the speech-based navigation to predefined information units. A browser 20 by which the information unit 27 is displayed is executed on the client 2. Information units such as the home page 27 used in this example of embodiment are stored on the server 6 as HTML pages (HyperText Markup Language). The client 2 sets up a connection through the Internet 4 by means of a link to the server 6 on which the home page 27 is stored. The links are also called hyperlinks. The home page 27, which can also contain graphical symbols, audio and/or video data in addition to the text to be displayed, is downloaded from this server 6. The client 2 has a microphone 22 which is used here as an input medium for the speech input. The speech input data which are available as analog signals are converted to digital signals by an audio unit 23 and rendered available to a software module 21. The speech input data are analyzed by the software module 21 and assigned to feature vectors. The client 2 is connected to a data file server 5 through the Internet 4. This data file server 5 stores assignments 25-26 under user identifiers ID, to IDn.

Either assignment 25-26 contains at least one word that is assigned to a respective link. The client 2 is furthermore connected to a speech recognition server 3 through the Internet 4. The connections 28 and 29 each represent a possible direct connection from the server 6 to the data file server 5 and from the speech recognition server 3 to the data file server 5. A determined link is directly transmitted from the data file server 5 to the server 6 via such a connection 28.

It is also possible to transmit the recognition result directly from a speech recognizer 8 to the data file server 5 via the connection 29. Then the client 2 also transmits user identifier IDn in addition to the feature vectors to the speech recognizer 8.

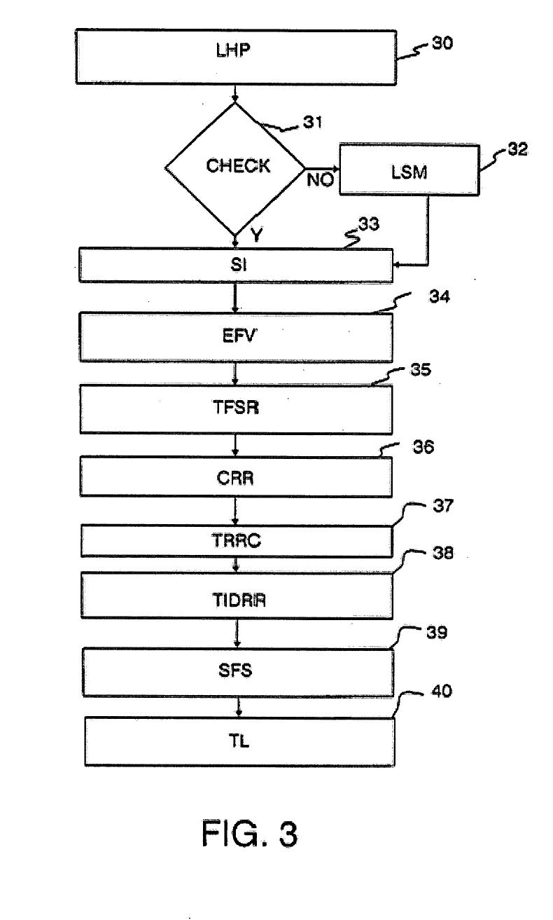

FIG. 3 shows with what steps a speech-based navigation is effected. In step 30 (LHP Load Home Page) the user of the client 2 downloads a home page 27 enabling a speech input, for example, from a server 6. The user may also be called visitor of the home page 27. In step 31 (CHECK) a check is made whether the client 2 accommodates the software module 21 for feature extraction. If this software module 21 is not available, it is loaded in step 32 (LSM Load Software Module) from the server 6 through the Internet 4 onto the client 2. After this private home page 27 has been indicated by the browser 20, the user launches a speech input in step 33 (SI Speech Input). This speech input is subdivided into feature vectors in step 34 (EFV Extract into Feature Vectors) by means of the software module 20. In step 35 (TMSR TransMit feature vectors to the Speech Recognizer) the feature vectors are transmitted to a speech recognition server 3. The speech recognizer 8 is then defined by an address of a speech recognition server 3 which the client 2 is informed of where the home page 27 is loaded. In step 36 (CRR Create Recognition Result) the speech recognizer 8 creates a recognition result from the transmitted feature vectors which come from a speech input uttered by the user. The recognition result is returned to the client 2 in step 37 (TRRC Transmit Recognition Result to the Client). In step 38 (TIDRR Transmit user IDentifier and Recognition Result) the recognition result together with a user identifier IDn, which was transmitted to the client 2 when the home page 27 was loaded, is transmitted to the data file server 5. In step 39 (SFS Search on File Server) a link is searched for by means of the user identifier IDn and the recognition result. The links to be searched for are assigned predefined words and the user identifiers ID1-IDn. The speech input uttered by a user then corresponds to one of the predefined words. In step 40 (TL Transmit Link), the determined link is transmitted to the client 2. By means of the link the web site or home page 27 connected with this link is loaded and displayed on the client 2 by means of the browser 20.

For starting a speech recording, the user activates with his mouse or keyboard a button 24 and utters a speech input. This speech input is subdivided into feature vectors as described earlier. The feature vectors are sent from the software module 21 to a defined speech recognizer 8 on the Internet 4. The speech recognizer 8 receives the feature vectors and produces a recognition result by means of a speech recognition program.

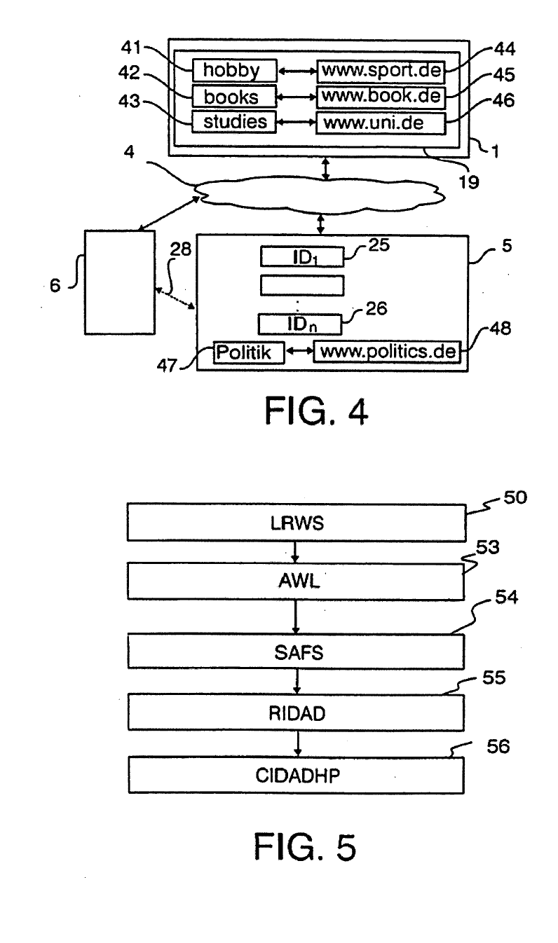

FIG. 4 represents an arrangement as is necessary for the implementation of a speech input possibility in private home pages 27. With this method a user of a client 1, who will be denoted the creator of the home page 27, carries out an assignment 25-26 of links 44-46 46 to predefined words 41-43. The client I downloads a registration information unit 19 from the server 6. By means of the registration information unit 19, the creator assigns respective links 44-46 to predefined words 41-43. The assignment 25-26 is individual. The respective predefined word 41-43 is known to a speech recognizer 8 and is recognized during a later correlating speech input. This individual assignment 25-26 is transmitted from the client I to the data file server 5 on which the assignment 25-26 is stored with a user identifier 1131-11), The data file server 5 sends to the client I the respective user identifier ID1-IDn, at which the assignment 25-26 of the creator was stored. Furthermore, the client 1 also receives an address of a speech recognition server 3 on which a speech recognizer 8 is arranged. The creator combines the address of the speech recognizer 8 and the user identifier IDn with his private home page 27. This is possible, for example, in that the address of the speech recognizer and the user identifier IDn are co-transmitted by means of a tag or additional information in the HTML code. The assignment is effected, for example, by keying in the link via the keyboard.

Alternatively, it is possible to select from a large number of predefined words, by selecting tag boxes with the mouse, a certain subsidiary number of words to which respective links are assigned. For verifying the predefined words it is possible that the creator enters the assigned words via speech input. These words are then transmitted to the speech recognizer 8 and recognized. The recognition result is returned to the client 1.

The speech recognizer recognizes not only the predefined words 41-43, but also user-independent words 47. The creator of the home page 27 assigns a link 44-46 to the predefined words 41-43. On the other hand, the service provider, for example the provider of the speech recognizer 8 or of the server 6, assigns links 48 to the user-independent words 47.

For this user-independent assignment it is necessary for the speech recognizer 8 also to recognize these user-independent words 47. The words 41-43, 47 that are recognized by the speech recognizer 8 are laid down by the provider of the speech recognizer 8.

When a user of a client does not have a home page 27 and does not wish to create a home page 27 either, it is nevertheless possible for him to navigate to predefined information units via a speech input. To this end, the user effects the assignment of the registration information unit 19, which is then transmitted to the data file server 5 to be stored under a user identifier IDn. From this data file server 5 is then transmitted a data file that can be displayed by the browser 20 and which data file contains the user identifier ID′, and the address of the speech recognizer. The user, when invoking this data file, can navigate with each speech input to the web pages determined by him or by the service provider.

On the server 6 on which the home page 27 of the creator is stored can in the simplest case also be stored the data file 5 with the assignments 25-26, and also the speech recognizer 8 can be arranged there. This arrangement is not shown. In such a case the feature vectors with user identifier IDn are transmitted from the client 2 to this single server 6. The recognition result produced by the speech recognizer 8 is transmitted directly to the server 6 of the data file 5 together with the user identifier ID, in which file the link to this recognition result and also to this user identifier IDn is determined. This link is then either returned to the client 2, or the web site combined with this link is transmitted to the client 2.

FIG. 5 shows the routine of the implementation of a speech input possibility in private home pages. In step 50 (LRWS Load Register Web Site) the creator of the home page 27 downloads the registration information unit 19 from a server 6. In step 53 (AWL Assign Words to Links), respective individual links 44-46 are assigned to the predefined words 41-43 by the creator. In step 54 (SAFS Send Assignments to File Server), the assignment provided by the creator is transmitted to the file server 5. In step 55 (RIDAD Receive user IDentifier and ADdress) the user identifier IDn, at which the assignment of the creator was stored, is transmitted to the client 2 from the data file server 5, as is the address of an additional speech recognizer 8. In step 56 (CIDADHP Connect user IDentifier and ADdress with Home Page) the creator connects the user identifier and the address with his home page. This home page, in which thus the speech input possibility was implemented, is stored on the server 6. When this home page is retrieved by a user, this user can now navigate in above-described manner per speech input to the predefined home pages or web sites.

The creator of a speech-based home page 27 assigns on a registration information unit 19 the following links to predefined words: “hobby∓www.sport.de”; “books—www.books.de”; “studies—www.uni.de”. This assignment is transmitted from the client I to the data file server 5. There the user of the client I is registered if he receives an individual user identifier IDn and his assignment 25-26 is stored on the data file server 5. To the client I is transmitted, for example, in the form of an E-mail the user identifier granted to him together with an address of the speech recognizer. The creator of the speech-based home page 27 combines both the user identifier IDn and the address of the speech recognizer 8 with his private home page 27. This home page is then, for example, stored on the server 6. In addition to the words 41-43 assigned by the creator, the service provider combines user-independent words 47 with user-independent links 48; for example, the word “politics−∓www.politics.de” or “telephone directory—). www.number.de”. The user of the client 2 accesses the creator's private home page 27. This is shown on the client 2 by the browser 20.

By means of a click of the mouse the user activates the button 24 and gives a speech input.

The word “books” spoken by the user is subdivided by the software module 21 into feature vectors which are then sent to the speech recognizer 8 known from the transmitted address.

There a recognition result is produced from the speech input “books” and sent back to the client 2. This recognition result is transmitted together with the user identifier IDn to the data file 5 in which the link www.books.de is defined under the creator's user identifier IDn and the recognition result. This link is transmitted to the client 2 and activated by the client 2. The web site connected with the link www.books.de is then displayed on the client 2. When the user of the client 2 pronounces “politics”, the web site www.politics.de will be displayed. When the user of the client 2 invokes a private home page of a second creator and this second creator has combined the word “books” with www.bookworm.de, the web site www.bookworm.de will be displayed when “books” is pronounced. With a speech input of the user-independent word 6 politics”, on the other hand, the same web site will be invoked just like the private home page 27 of the first creator.

When a speech input possibility is implemented in the home page of a web site of companies, the creator assigns links to web pages from all the web sites. As a result, it is possible to reach web pages of the individual sub-ranges of a company for each language. The speech recognizer is matched to the vocabulary of a company via the predefined words. The specific vocabulary may contain, for example, product names, so that a visitor of such a speech-based company home page is shown the respective web pages on his client by pronouncing the product names or brand names in which he takes an interest.

The user-independent words can be assigned to interested parties by means of commercial transactions, so that when the user-independent word is pronounced, the web page of the interested party is automatically invoked or activated. This link is effected by the provider of the speech recognizer who has to take care that this user-independent word is sold or rented to only one interested party. The web page of the interested party may also be linked with a plurality of words so that, for example, with connotations belonging to a theme always the same web page is invoked. The user-independent words may be temporarily issued to interested parties. In addition, it is possible to invoke or activate such a web page via a speech utterance which is recognized in different languages.

In order to guarantee such a function, the respective word or speech utterance, or the pronunciation of the word respectively, in different languages in the speech recognizer is made known by the provider of the speech recognizer. A user of a speech-based web site now effects a respective speech input. This is recognized by the speech recognizer and the produced recognition result is sent back to the invoking client. The recognition result is sent with the user identifier, where appropriate, to the data file in which the assigned link is determined and either sent back to the client, or the web page connected with the link is transmitted to the client.

Although various exemplary embodiments of the invention have been disclosed, it should be apparent to those skilled in the art that various changes and modifications can be made which will achieve some of the advantages of the invention without departing from the true scope of the invention.

1. A method of speech-based navigation in a communications network (4), comprising the following steps:
a client (2) downloads a private information unit (27) enabling a speech input from a server (6),
a speech recognizer (8) produces a recognition result from an uttered speech input, said speech input recognizer being remotely located from the client (2) and said private information unit subdividing the uttered speech input into feature vectors, wherein said recognition result is performed after the feature vectors are transmitted to the speech recognizer via the server, and
with the recognition result a link (44-46, 48) to an information unit in a data file (5) is determined which is assigned to a word (41-43, 47) that correlates with the recognition result.

2. A method as claimed in claim 1, characterized in that the respective link (44- 46, 48) can be activated via a plurality of speech inputs and/or the respective link (44-46, 48) can be activated via a plurality of speech inputs in different languages.

3. A method as claimed in claim 1, characterized in that the private information unit (27) contains a user identifier (IDn) and the link (44-46, 48) is determined with the recognition result and the user identifier (IDn,) in the data file (5), which link is assigned to a word (41-43, 47) that correlates with the recognition result and is assigned to the user identifier (IDn).

4. A method as claimed in claims 1 and 3, characterized in that the determined link is returned to the client (2) upon its invocation and output.

5. A method as claimed in claims 1 and 3, characterized in that the information unit connected with the determined link is transmitted to the client (2) to be invoked and output.

6. A method as claimed in claim 1, characterized in that the private information unit (27) contains an address of a speech recognizer (8) and the speech recognition is executed on a speech recognition server (3) connected through the communications network (4).

7. A method as claimed in claim 1, characterized in that the speech recognition is executed locally on the client (2).

8.1 A method as claimed in claims 1 and 3, characterized in that the speech recognizer (8) recognizes in addition to predefined words (41-43) also user-independent words (47) to which links (48) are assigned by the service provider and in that, in the case of a speech input correlating with the user-independent words (47) and a recognition result produced therefrom, a user-independent link (48) is determined independently of the user identifier (IDn).

9. A method as claimed in claim 1, characterized in that when the private information unit (27) is invoked, a test is made whether a software module (21) is present on the invoking client (1, 2), which software module is necessary for feature extraction of the speech input and for the transmission to the speech recognizer (8), and this software module, if absent, is downloaded from the server (6).

10. A method as claimed in claim 1, characterized in that at least temporarily an interested party is assigned a right to activate an information unit assigned per link (48) with at least one expression in a natural language that can be recognized by the speech recognizer (8).

11. A method of implementing a speech input possibility in private information units (27) for speech-based navigation in a communications network (4);
in which a registration information unit (19) is downloaded from the server (6) by means of a client (1), by means of which registration information unit (19) user-specific links (44-46) are assigned to the predefined words (41-43), and the assignment (25, 26) with a user identifier (IDn) is transmitted to a data file (5) and
in which the user identifier (IDn) and an address of a speech recognizer (8) which can each be combined with a private information unit (27) are transmitted to the client (1).

12. A method as claimed in claim 11, characterized in that at least one word (41-43) is combined with a link (44-46) and this assignment (25, 26) is stored in the data file (5) with the individual user identifier (IDn) which each user receives on registration.

13. A method as claimed in claims 1, 8 and 11, characterized in that after the assignment an information unit containing a user identifier (IDn) and an address of a speech recognizer (8) is transmitted to a user for whom no private information unit (27) exists, by means of which information unit the user is enabled to invoke the assigned information units per speech input.

14. A method as claimed in claim 1 or 11, characterized in that the registration information unit (19), the private information unit (27), the speech recognizer (8) and the data file (5) are stored on one (7) or on several servers (3, 5, 6) connected per communications network (4).

15. A software module (21) for implementing the method as claimed in claim 1.

16. A software module as claimed in claim 15, characterized in that it is activated by means of an operating element (24).

17. A computer on which a software module (21) as claimed in claim 15 is executed.
